(19) United States
(12) Patent Application Publication
(10) Pub. No.: US 2022/0417876 A1
(43) Pub. Date: Dec. 29, 2022

(54) DISTRIBUTED ANTENNA SYSTEM IMPLEMENTED OVER OPEN RADIO ACCESS NETWORK

(71) Applicant: CommScope Technologies LLC, Hickory, NC (US)

(72) Inventors: Christopher Goodman Ranson, Concord, VA (US); Irfaan Ahamed Salahuddeen, Acton, MA (US); Thomas Kummetz, Kissing (DE)

(73) Assignee: CommScope Technologies LLC, Hickory, NC (US)

(21) Appl. No.: 17/848,784

(22) Filed: Jun. 24, 2022

Related U.S. Application Data
(60) Provisional application No. 63/215,254, filed on Jun. 25, 2021.

(51) Int. Cl. H04W 56/00; H04W 24/02

(52) U.S. Cl. CPC H04W 56/001; H04W 24/02; H04W 88/085

(57) ABSTRACT

One embodiment is directed to an open radio access network (O-RAN) distributed antenna system (DAS) that comprises a central access node (CAN) configured to communicatively couple at least one O-RAN distributed unit (O-DU) to the O-RAN DAS, where the O-DU is configured to communicate with a single O-RAN remote unit (O-RU) entity. The O-RAN DAS also includes a plurality of O-RAN remote units (O-RUs) communicatively coupled to the CAN over a fronthaul network, where the O-DU, CAN, and O-RUs are configured to natively use an O-RAN fronthaul interface to communicate fronthaul data over the fronthaul network. The CAN is configured to appear to the O-DU as the single O-RU entity for a cell served by the O-DU even though the CAN is configured to serve the cell using multiple O-RUs that form a simulcast group for that cell. One or more CANs can be used. Other embodiments are disclosed.

### CROSS-REFERENCE TO RELATED APPLICATIONS

This application claims the benefit of U.S. Provisional Patent Application Ser. No. 63/215,254, filed on Jun. 25, 2021, entitled “DISTRIBUTED ANTENNA SYSTEM IMPLEMENTED OVER OPEN RADIO ACCESS NETWORK”, the entirety of which is incorporated herein by reference.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote units”), where each remote unit can be coupled directly to one or more of the central access nodes or indirectly via one or more other remote units and/or via one or more intermediary or expansion units or nodes (also referred to here as “transport expansion nodes (TENs)”). A DAS is typically used to improve the coverage provided by one or more base stations that are coupled to the central access nodes. These base stations can be coupled to the one or more central access nodes via one or more cables or via a wireless connection, for example, using one or more donor antennas. The wireless service provided by the base stations can include commercial cellular service and/or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the remote units. Each remote unit receives the downlink transport signals transmitted to it from one or more central access nodes and uses the received downlink transport signals to generate one or more downlink radio frequency signals that are radiated from one or more coverage antennas associated with that remote unit. The downlink radio frequency signals are radiated for reception by user equipment. Typically, the downlink radio frequency signals associated with each base station are simulcasted from multiple remote units. In this way, the DAS increases the coverage area for the downlink capacity provided by the base stations.

Likewise, each remote unit receives one or more uplink radio frequency signals transmitted from the user equipment. Each remote unit generates one or more uplink transport signals derived from the one or more uplink radio frequency signals and transmits them to one or more of the central access nodes. Each central access node receives the respective uplink transport signals transmitted to it from one or more remote units and uses the received uplink transport signals to generate one or more uplink base station radio frequency signals that are provided to the one or more base stations associated with that central access node. Typically, this involves, among other things, combining or summing uplink signals received from multiple remote units in order to produce the base station signal provided to each base station. In this way, the DAS increases the coverage area for the uplink capacity provided by the base stations.

The DAS can use either digital transport, analog transport, or combinations of digital and analog transport for generating and communicating the transport signals between the central access nodes, the remote units, and any transport expansion nodes.

Typically, such a DAS is operated in a “simulcast” mode in which downlink signals for each base station are transmitted from multiple remote units of the DAS and in which uplink signals for each base station are generated by combining signals from multiple remote units.

Moreover, if digital transport is used in the DAS, the user-plane data is typically communicated as time-domain baseband in-phase and quadrature (IQ) data using a proprietary synchronous protocol. That is, a proprietary “Option 8” functional split is used for fronthaul transport within the DAS. The typical interface between each base station and each central access node is an analog radio frequency (RF) interface, in which case one of the functions of the central access node is converting between the analog RF interface used for interfacing with the base station and the proprietary synchronous time-domain baseband IQ protocol used for transport between the nodes of the DAS. Some digital DASs support interfacing a central access node directly to a baseband unit (BBU) of a base station using the proprietary time-domain baseband IQ protocol supported by the BBU (which is typically based on the Common Public Radio Interface (“CPRI”) protocol), in which case one of the functions of the central access node is converting between the proprietary time-domain baseband IQ protocol used by the BBU and the proprietary synchronous time-domain baseband IQ protocol used for transport between the nodes of the DAS. However, due to the proprietary nature of the time-domain baseband IQ protocols used by BBU vendors, most digital DASs typically support interfacing with only a limited number of types of BBUs.

Also, because of the proprietary transport protocols used in the DAS, custom hardware is typically used to implement the various nodes of a DAS.

The O-RAN Alliance has developed an open, standardized fronthaul interface. (“O-RAN” is an acronym for “Open RAN.”) The initial version of the O-RAN fronthaul interface was developed to enable point-to-point communication between a distributed unit (DU) and a remote unit (RU) using an open standardized protocol. This protocol supports an “Option 7.2” functional split, where the O-RAN DU (O-DU) implements all Layer 3 and Layer 2 functions as well as the “upper” Layer 1 functions and the O-RAN RU (O-RU) implements the “lower” Layer 1 functions as well as the RF functions. With this protocol, user-plane data is communicated as frequency-domain baseband IQ data between the O-DU and the O-RU. With O-RAN, the fronthaul can be implemented using a switched Ethernet network.

The O-RAN Alliance has commissioned a Shared-Cell Working Group to develop specifications that support point-to-multipoint topologies (that is, a single O-DU serving multiple O-RUs) and simulcasting. One proposal for implementing a point-to-multipoint topology employs an intermediary node (referred to as a front-haul manager (FHM)) between the O-DU and the multiple O-RUs. In order to reduce the fronthaul bandwidth required at the O-DU, the FHM duplicates packets in the downlink direction and combines user-plane data in the uplink direction. However, the specifications developed by the Shared-Cell Working Group are likely to require the O-DU and/or the O-RUs to support optional features that are specific to the Shared-Cell use case.

### SUMMARY

One embodiment is directed to an open radio access network (O-RAN) distributed antenna system (DAS). The O-RAN DAS comprises a central access node (CAN) configured to communicatively couple at least one O-RAN distributed unit (O-DU) to the O-RAN DAS. The O-DU is configured to communicate with a single O-RAN remote unit (O-RU) entity. The O-RAN DAS further comprises a plurality of O-RAN remote units (O-RUs) communicatively coupled to the CAN over a fronthaul network. The O-DU, CAN, and O-RUs are configured to natively use an O-RAN fronthaul interface to communicate fronthaul data over the fronthaul network. The CAN is configured to appear to the O-DU as the single O-RU entity for a cell served by the O-DU even though the CAN is configured to serve the cell using multiple O-RUs that form a simulcast group for that cell. The CAN is configured to: receive, at the CAN, each downlink packet for downlink O-RAN control-plane and user-plane communications transmitted from each O-DU using a unicast destination address; change the destination unicast address of each received downlink control-plane and user-plane packet to a multicast address associated with the simulcast group used for the cell; transmit each updated downlink control-plane and user-plane packet to the multiple O-RUs in the simulcast group using the multicast address; receive, at the CAN, each uplink packet for uplink O-RAN user-plane communications transmitted from the multiple O-RUs in the simulcast group for the cell; perform a digital summation process for corresponding uplink baseband IQ samples in corresponding uplink user-plane packets received from the multiple O-RUs in the simulcast group for the cell in order to produce respective summed uplink packets including the summed uplink based IQ samples; and transmit the summed uplink packets to the O-DU.

Another embodiment is directed to a method for use with an open radio access network (O-RAN) distributed antenna system (DAS). The O-RAN DAS comprises a central access node (CAN) configured to communicatively couple at least one O-RAN distributed unit (O-DU) to the O-RAN DAS. The O-DU is configured to communicate with a single O-RAN remote unit (O-RU) entity. The O-RAN DAS further comprises a plurality of O-RAN remote units (O-RUs) communicatively coupled to the CAN over a fronthaul network. The O-DU, CAN, and O-RUs are configured to natively use an O-RAN fronthaul interface to communicate fronthaul data over the fronthaul network. The CAN is configured to appear to the O-DU as the single O-RU entity for a cell served by the O-DU even though the CAN is configured to serve the cell using multiple O-RUs that form a simulcast group for that cell. The method comprises: receiving, at the CAN, each downlink packet for downlink O-RAN control-plane and user-plane communications transmitted from each O-DU using a unicast destination address; changing the destination unicast address of each received downlink control-plane and user-plane packet to a multicast address associated with the simulcast group used for the cell; transmitting each updated downlink control-plane and user-plane packet to the multiple O-RUs in the simulcast group using the multicast address; receiving, at the CAN, each uplink packet for uplink O-RAN user-plane communications transmitted from the multiple O-RUs in the simulcast group for the cell; performing a digital summation process for corresponding uplink baseband IQ samples in corresponding uplink user-plane packets received from the multiple O-RUs in the simulcast group for the cell in order to produce respective summed uplink packets including the summed uplink based IQ samples; and transmitting the summed uplink packets to the O-DU.

Other embodiments are disclosed.

The details of various embodiments are set forth in the accompanying drawings and the description below. Other features and advantages will become apparent from the description, the drawings, and the claims.

### DRAWINGS

FIG. 1 illustrates one exemplary embodiment of an O-RAN distributed antenna system.

FIG. 2 comprises a high-level flowchart illustrating one exemplary embodiment of a method of supporting simulcast transmission in an O-RAN DAS.

FIG. 3 comprises a high-level flowchart illustrating one exemplary embodiment of a method of supporting simulcast reception in an O-RAN DAS.

FIG. 4 is a block diagram illustrating one exemplary embodiment of a single-entity O-RU that can be used in the O-RAN DAS of FIG. 1.

FIG. 5 is a block diagram illustrating one exemplary embodiment of a multi-entity O-RU that can be used in the O-RAN DAS of FIG. 1.

FIG. 6 illustrates one exemplary embodiment of an O-RAN DAS that supports base station entities that do not natively support the fronthaul interface used in the O-RAN DAS.

Like reference numbers and designations in the various drawings indicate like elements.

### DETAILED DESCRIPTION

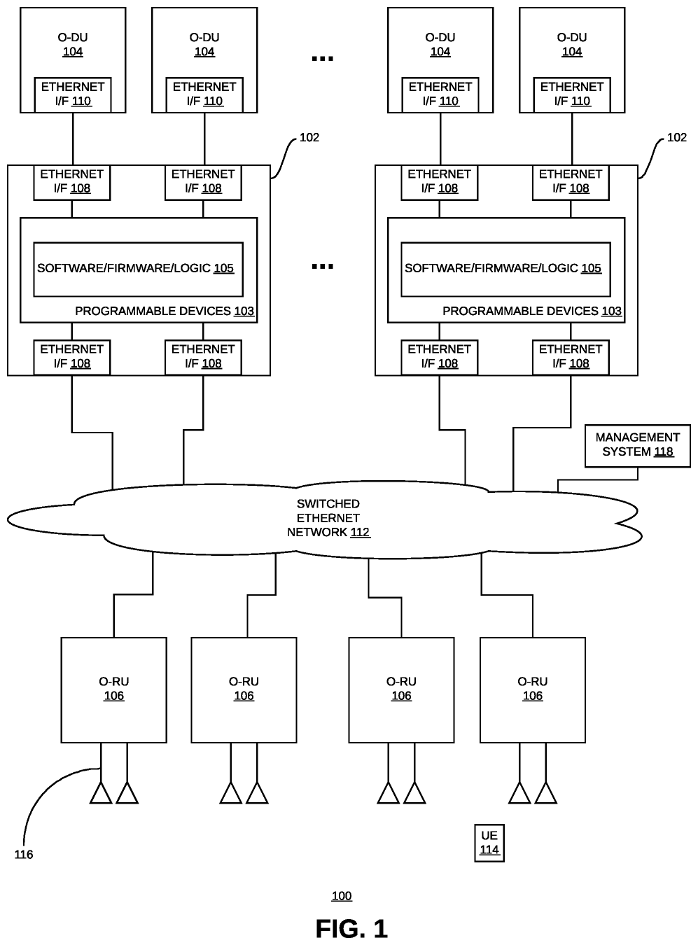

FIG. 1 illustrates one exemplary embodiment of an O-RAN distributed antenna system 100.

The O-RAN DAS 100 comprises one or more DAS central access nodes (CANs) 102. Each DAS CAN 102 is configured to couple one or more O-RAN distributed units (O-DUs) 104 to a plurality of O-RAN remote units (O-RUs) 106.

In the exemplary embodiment shown in FIG. 1, each O-DU 104 is co-located with at least one DAS CAN 102 that serves that O-DU 104. In other embodiments, one or more of the O-DUs 104 is located remotely from the particular DAS CAN 102 to which it is coupled. At least some of the O-RUs 106 are remotely located from the one or more DAS CANs 102 serving those O-RUs 106 and from at least one of the other O-RUs 106.

Each DAS CAN 102 comprises one or more programmable devices 103 that execute, or are otherwise programmed or configured by, software, firmware, or configuration logic 105 in order to implement the functionality described here as being performed by the DAS CAN 102. The one or more programmable devices 103 can be implemented in various ways (for example, using programmable processors (such as microprocessors, co-processors, and processor cores integrated into other programmable devices) and/or programmable logic (such as field programmable gate arrays (FPGAs) and system-on-chip packages)). Where multiple programmable devices are used, all of the programmable devices do not need to be implemented in the same way.

Each DAS CAN 102 includes one or more Ethernet interfaces 108.

In one implementation, each DAS CAN 102 comprises a separate set of Ethernet interfaces 108 that are “directly” connected to the fronthaul Ethernet interfaces 110 of the O-DU 104. An Ethernet interface 108 of a DAS CAN 102 is directly connected to an Ethernet interface 110 of an O-DU 104 in the sense that there is no Ethernet switch in the physical communication link between those Ethernet interfaces 108 and 110 (though there may be passive equipment (such as patch panels and patching cables) in the communication link). In other embodiments, each O-DU 104 is coupled to one or more DAS CANs 102 over a switched Ethernet network instead of using direct connections. In such alternative embodiments, each O-DU 104 does not necessarily need to be co-located with at least one DAS CAN 102 that serves that O-DU 104.

In the exemplary embodiment shown in FIG. 1, the O-RUs 106 are coupled to one or more DAS CANs 102 via a fronthaul network. In the exemplary embodiment shown in FIG. 1, the fronthaul network comprises a switched Ethernet network 112. The switched Ethernet 112 can be implemented using one or more conventional Ethernet switches. Each DAS CAN 102 is coupled to the switched Ethernet network 112 via one or more of the Ethernet interfaces 108 included in that DAS CAN 102.

The O-RAN DAS 100 is configured to support simulcasting. That is, for a cell served by an O-DU 104, multiple O-RUs 106 transmit and receive RF signals to and from user equipment (UEs) 114. Each set of multiple O-RUs 106 used to serve a given cell is referred to here as a “simulcast group” for that cell. Each O-RU 106 transmits and receives RF signals to and from UEs 114 using a respective one or more antennas 116 associated with that O-RU 106.

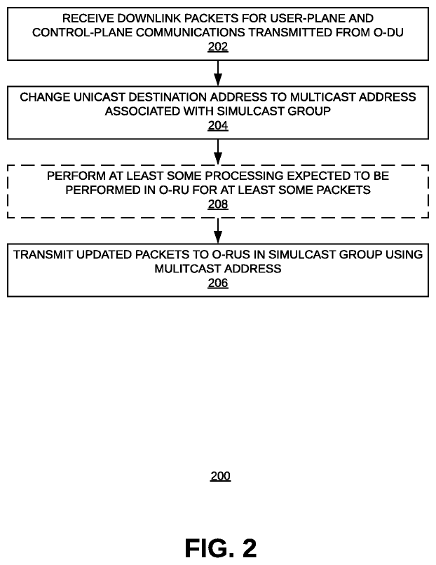

The O-RAN DAS 100 is configured to support and enable simulcast transmission and reception using multiple O-RUs 106, even if the O-DUs 104 and/or the O-RUs 106 do not natively support simulcast transmission and reception using multiple O-RUs 106. Each DAS CAN 102 is configured to “appear” to each O-DU 104 it is coupled to as a single, standard O-RU entity for a cell served by that O-DU 104 even though multiple O-RUs 106 are actually being used to serve that cell. Also, each DAS CAN 102 is configured to “appear” to each O-RU 106 as a standard O-DU entity for a cell served by that O-RU 106. Additional details regarding how the O-RAN DAS 100 is configured to support and enable simulcast transmission and reception is described below in connection with FIG. 2.

The O-RAN DAS 100, and each DAS CAN 102, can be configured to work with one or more O-DUs 104 (or other base station entities) and to support one or more simulcast groups. That is, as shown in FIG. 1, each DAS CAN 102 can be configured to work with a single O-DU 104 (or other base station entity) or can be configured to work with multiple O-DUs 104 (or other base station entities). Each of the DAS CANs 102 need not be configured in the same way or for use with the same type or number of O-DUs 104 (or other base station entities) as the other DAS CANs 102 (if any) used in the O-RAN DAS 100. Moreover, as described in more detail below, each O-RU 106 can be implemented using a physical O-RU 106 that is capable of implementing only a single O-RU entity or a physical O-RU 106 that is capable of implementing multiple O-RU entities, in which case each such O-RU entity may be used with a different O-DU 104 (or other base station entity) and may be used with a different simulcast group.

FIG. 2 comprises a high-level flowchart illustrating one exemplary embodiment of a method 200 of supporting simulcast transmission in an O-RAN DAS. The embodiment of method 200 is described here as being implemented using the embodiment of an O-RAN DAS 100 described above in connection with FIG. 1, though other embodiments can be implemented in other ways.

The blocks of the flow diagram shown in FIG. 2 have been arranged in a generally sequential manner for ease of explanation; however, it is to be understood that this arrangement is merely exemplary, and it should be recognized that the processing associated with method 200 (and the blocks shown in FIG. 2) can occur in a different order (for example, where at least some of the processing associated with the blocks is performed in parallel and/or in an event-driven manner). Also, most standard exception handling is not described for ease of explanation; however, it is to be understood that method 200 can and typically would include such exception handling.

The embodiment of method 200 shown in FIG. 2 is described here as being performed for a particular cell served by the O-RAN DAS 100, which is referred to here as the “current” cell.

Method 200 comprises receiving, at the DAS CAN 102, downlink packets for downlink O-RAN control-plane and user-plane communications transmitted from the O-DU 104 serving the current cell using a unicast destination address (block 202), changing the destination unicast address of the received downlink control-plane and user-plane packets to a multicast address associated with the simulcast group used for the current cell (block 204), and transmitting the updated downlink control-plane and user-plane packets to the O-RUs 106 in the simulcast group using the multicast address (block 206).

The O-DU 104 is configured to use unicast transmission to transmit downlink O-RAN control-plane and user-plane communications to one or more unicast addresses (for example, one or more Ethernet MAC addresses or one or more Internet Protocol (IP) addresses) that, from the perspective of that O-DU 104, are associated with a single O-RU entity when in reality those one or more addresses are associated with the DAS CAN 102.

For each downlink packet used for such downlink O-RAN control-plane and user-plane communications that is received by the DAS CAN 102 from the O-DU 104, the DAS CAN 102 replaces the unicast destination address in that packet with the multicast address assigned to the simulcast group used to serve the current cell and transmits the updated packet to that multicast address over the switched Ethernet network 112 used for the fronthaul.

The DAS CAN 102 is configured to communicate the multicast address assigned to the simulcast group to each O-RU 106 in that simulcast group. This can be done using an O-RAN management plane message. Each O-RU 106 is configured to register with that multicast address in order to receive the downlink packets multicasted to that multicast address. This process can be done as a part of the configuration process for the O-RAN DAS 100.

In the exemplary embodiment shown in FIG. 2, method 200 further comprises performing, by the DAS CAN 102, at least some processing for the current cell that the O-DU 104 expects to be performed in an O-RU entity for at least some of the received downlink control-plane and/or user-plane packets (block 208). This feature is optional. For those downlink packets for which such processing is performed, the resulting processed downlink data is included in the corresponding updated downlink packets transmitted to the O-RUs 106 in the simulcast group using the multicast address (block 206).

The various O-RAN specifications specify that some processing for a given cell can be performed in an O-RU entity instead of in the O-DU entity. For example, where an Option 7.2 functional split is used, the O-RU entity is configured to implement the lower Layer 1 functions in addition to the RF functions. In addition, the initial version of the O-RAN specifications support two different types of O-RU entities. The difference between the two types of O-RU entities is whether precoding for the downlink is performed in the O-DU or the O-RU. An O-RU entity that is not configured to perform the downlink precoding is referred to as a “Category A” O-RU, whereas an O-RU entity that is configured to perform the downlink precoding is referred to as a “Category B” O-RU. In some implementations, the DAS CAN 102, as a part of appearing to a given O-DU 104 to be a single, standard O-RU entity, is configured to perform some processing that the O-DU 104 is expecting to have performed in the standard O-RU entity. In one example, Category A O-RUs 106 are used with an O-RAN DU 104 that is configured to be used with a Category B O-RU entity (that is, is configured so as to expect downlink precoding to be performed in the O-RU). In this example, the DAS CAN 102 performs the precoding for the downlink user-plane packets that the O-DU 104 is expecting to be performed in an O-RU entity. The resulting precoded user-plane data is included in the corresponding updated downlink packets transmitted to the O-RUs 106 in the simulcast group using the multicast address.

Other types of processing can be performed in the DAS CAN 102 (for example, digital beamforming, decompression processing if the O-DU 104 is configured to compress downlink user-plane data using a compression technique that is not supported by the O-RUs 106 in the simulcast group and/or compression processing if the O-RUs 106 in the simulcast group use a compression technique that is not supported by the O-DU 104).

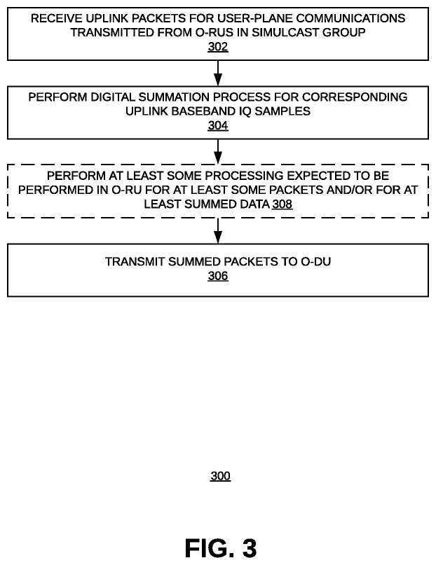

FIG. 3 comprises a high-level flowchart illustrating one exemplary embodiment of a method 300 of supporting simulcast reception in an O-RAN DAS. The embodiment of method 300 is described here as being implemented using the embodiment of an O-RAN DAS 100 described above in connection with FIG. 1, though other embodiments can be implemented in other ways.

The blocks of the flow diagram shown in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel and/or in an event-driven manner). Also, most standard exception handling is not described for ease of explanation; however, it is to be understood that method 300 can and typically would include such exception handling.

The embodiment of method 300 shown in FIG. 3 is described here as being performed for a particular cell served by the O-RAN DAS 100, which is referred to here as the “current” cell.

Method 300 comprises receiving, at the DAS CAN 102, uplink packets for uplink O-RAN user-plane communications transmitted from the O-RUs 106 in the simulcast group used for the current cell (block 302), performing a digital summation process for corresponding uplink baseband IQ samples in corresponding uplink user-plane packets received from the O-RUs 106 in the simulcast group in order to produce respective summed uplink packets including the summed uplink based IQ samples (block 304), and transmitting the summed uplink packets to the O-DU 104 serving the current cell (block 306).

Each O-RU 106 is configured to use unicast transmission to transmit uplink O-RAN user-plane communications to one or more unicast addresses (for example, one or more Ethernet MAC addresses or one or more Internet Protocol (IP) addresses) that, from the perspective of that O-RU 106, are associated with an O-DU entity when in reality those one or more addresses are associated with the DAS CAN 102.

The DAS CAN 102 is configured to receive the uplink user-plane packets sent from the various O-RUs 106 included in the simulcast group serving the current cell.

The digital summation process comprises having the DAS CAN 102 extract the uplink baseband IQ samples produced at those O-RUs 106 (decompressing the baseband IQ samples if necessary), identify corresponding uplink baseband IQ samples, digitally sum corresponding samples, and compress the summed baseband IQ samples if necessary. An uplink baseband IQ sample “corresponds” to other uplink baseband IQ samples if those samples are all associated with the same sample position within the associated symbol interval for the same resource element. The compression scheme (including no compression scheme) used for the uplink user-plane packets communicated from the O-RUs 106 to the DAS CAN 102 need not be the same as the compression scheme (including no compression scheme) used between the DAS CAN 102 and the O-DU 104.

The digitally summing may also include scaling the uplink baseband IQ samples from one or more of the O-RUs 106 (that is, changing the gain of the some of the input uplink baseband IQ samples), scaling the resulting summed uplink baseband IQ samples (that is, changing the gain of the output summed uplink baseband IQ samples), or implementing some type of limiter so the summed uplink baseband IQ samples do not exceed the available bit-width of the IQ data. If it is determined that a packet received from an O-RU 106 has one or more errors, the uplink baseband IQ samples contained in the packet may be included or excluded from the digital summation operation according to an error handling algorithm. Criteria for excluding the baseband IQ samples can include how many errors are in the packet and how often errors are received from that O-RU 106. Also, if a high percentage of packets from an O-RU 106 (or other network element) are missing (that is, are not received when expected), then all packets from that O-RU 106 may be excluded from the digital summing operation until such packets are again regularly received from that O-RU 106. Generally, the DAS CAN 102 can be configured to determine when to expect uplink user-plane packets from the O-RUs 106 based on the downlink control-plane communications received from the O-DU 104 for that current cell (that is, from the scheduling information included in those downlink control-plane communications).

In the exemplary embodiment shown in FIG. 3, method 300 further comprises performing, by the DAS CAN 102, at least some processing for the current cell that the O-DU 104 expects to be performed in an O-RU entity for at least some of the received uplink user-plane packets and/or for at least some of the summed uplink user-plane data (block 38). This feature is optional. The resulting processed uplink data is included in the corresponding summed uplink packets transmitted to the O-DU 104 (block 306).

In one example, O-RUs 106 that are not able to perform uplink digital beamforming are used with an O-RAN DU 104 that is configured to be used with an O-RU entity that is able to do so. In this example, the DAS CAN 102 performs the uplink digital beamforming that the O-DU 104 expects to be performed in an O-RU entity. This can be done on the uplink baseband IQ samples before or after the digital summation process is performed, in either case uplink digital beamforming will have been performed for the resulting corresponding summed uplink packets transmitted to the O-DU 104. Other types of processing can be performed in the DAS CAN 102.

By performing the processing associated with methods 200 and 300, the O-RAN DAS 100 increases the coverage area for the base station capacity provided for the current cell. Also, as a result of having the DAS CAN 102 performing some of the processing for the current cell that the O-DU 104 expects to be performed in an O-RU entity, O-RUs 106 that are not capable of performing all of the processing for the current cell that the O-DU 104 expects to be performed in an O-RU entity can nevertheless still be used with that O-DU 104. For example, Category A O-RUs 106 can be used with an O-DU 104 that is configured to be used with a Category B O-RU entity. It is expected that Category A O-RUs 106 will be less costly, at least in part due to not including downlink precoding functionality. Likewise, it is expected that O-DUs 104 that are configured to be used only with a Category B O-RU entity will be less costly, at least in part due to not including downlink precoding functionality. Since the O-RAN DAS 100 is configured to serve each cell using multiple O-RUs 106, it is especially advantageous to be able to use less costly O-RUs 106 (by using Category A O-RUs 106 instead of Category B O-RUs 106), even if used with less costly O-DUs 104 that do not natively support such O-RUs 106.

Each DAS CAN 102, O-DU 104, and O-RU 106 that is a part of the O-RAN DAS 100 can use the standard time synchronization features provided by O-RAN. That is, each DAS CAN 102, O-DU 104, and O-RU 106 is configured to use one of the time synchronization protocols supported by O-RAN (for example, the Institute of Electrical and Electronics Engineers (IEEE) 1588 Precision Time Protocol (PTP) and Synchronous Ethernet (SyncE) protocol) to synchronize itself to the timing master entity established for the O-RAN DAS 100. In one example, one of the O-DUs 104 serves as the timing master entity for the entire O-RAN DAS 100 and each of the other O-DUs 104, each DAS CAN 102, and each O-RU 106 synchronizes itself to that timing master entity. In another example, a separate external timing master entity is used and each DAS CAN 102, O-DU 104, and O-RU 106 synchronizes itself to that external timing master entity.

A management system 118 can use the standard management plane protocol supported by O-RAN to manage each DAS CAN 102, O-DU 104, and O-RU 106 that is a part of the O-RAN DAS 100. For example, the management system 118 can be used to define the various simulcast groups and the associated multicast addresses and configure each DAS CAN 102 and O-RU 106 accordingly.

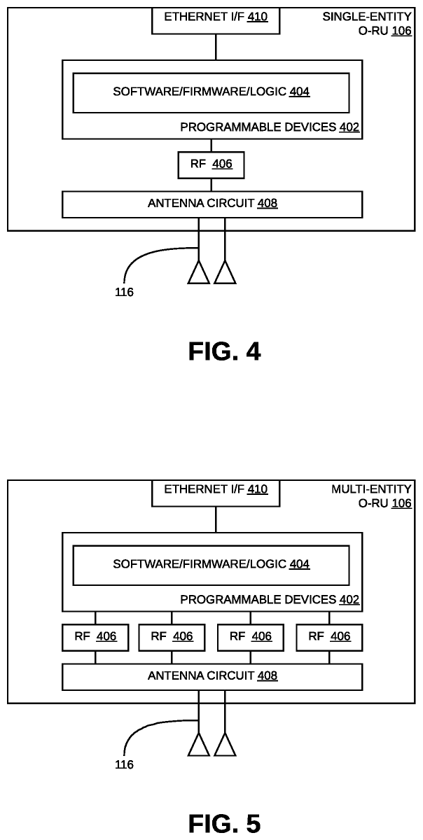

Each physical O-RU 106 in the O-RAN DAS 100 can be configured so that only a single O-RU entity can be implemented using that physical O-RU 106. Such a physical O-RU 106 is also referred to here as a “single-entity O-RU 106.” One example of a single-entity O-RU 106 is shown in FIG. 4. Also, each physical O-RU 106 in the O-RAN DAS 100 can be configured so that multiple O-RU entities can be implemented using that physical O-RU 106. Such a physical O-RU 106 is also referred to here as a “multi-entity O-RU 106.” One example of a multi-entity O-RU 106 is shown in FIG. 5.

FIG. 4 is a block diagram illustrating one exemplary embodiment of a single-entity O-RU 106 that can be used in the O-RAN DAS 100 of FIG. 1.

The single-entity O-RU 106 comprises one or more programmable devices 402 that execute, or are otherwise programmed or configured by, software, firmware, or configuration logic 404 in order to implement Layer-1 baseband processing described here as being performed by the O-RU entity implemented using that physical O-RU 106. The one or more programmable devices 402 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way.

In the exemplary embodiment shown in FIG. 4, the single-entity O-RU 106 comprises a single radio frequency (RF) module 406. The RF module 406 comprises circuitry that implements the RF transceiver functions for a single O-RU entity implemented using that physical O-RU 106 and provides an interface to one or more antennas 116 associated with that O-RU 106. Each RF module can be implemented using one or more RF integrated circuits (RFICs) and/or discrete components.

Each RF module 406 comprises circuitry that implements, for the associated O-RU entity, a respective downlink and uplink signal path for each of the antennas 116 associated with that physical O-RU 106. In one exemplary implementation, each downlink signal path receives the downlink baseband IQ data output by the one or more programmable devices 402 for the associated antenna 116, converts the downlink baseband IQ data to an analog signal (including the various physical channels and associated sub carriers), upconverts the analog signal to the appropriate RF band (if necessary), and filters and power amplifies the analog RF signal. (The up-conversion to the appropriate RF band can be done directly by the digital-to-analog conversion process outputting the analog signal in the appropriate RF band or via an analog upconverter included in that downlink signal path.) The resulting amplified downlink analog RF signal output by each downlink signal path is provided to the associated antenna 116 via an antenna circuit 408 (which implements any needed frequency-division duplexing (FDD) or time-division-duplexing (TDD) functions).

In one exemplary implementation, the uplink RF analog (including the various physical channels and associated sub carriers) received by each antenna 116 is provided, via the antenna circuit 408, to an associated uplink signal in the RF module 406.

Each uplink signal path in each RF module 406 receives the uplink RF analog received via the associated antenna 116, low-noise amplifies the uplink RF analog signal, and, if necessary, filters and, if necessary, down-converts the resulting signal to produce an intermediate frequency (IF) version of the signal.

Each uplink signal path in each RF module 406 converts the resulting analog signals to real digital samples and outputs them to the one or more programmable logical devices 402 for uplink signal processing. (The analog-to-digital conversion process can be implemented using a direct RF ADC that can receive and digitize RF signals, in which case no analog down-conversion is necessary.)

The single-entity O-RU 106 further comprises at least one network interface 410 that is configured to communicatively couple the single-entity O-RU 106 to the switched Ethernet 112 and, ultimately, the DAS CAN 102.

The single-entity O-RU 106 is configured to implement a single O-RU entity, where each such O-RU entity appears to the associated O-DU 104 (and the DAS CAN 102) as a separate logical O-RU entity. The single-entity O-RU 106 can also be used with other base station entities. In one implementation, each single-entity O-RU 106 is not “hardwired” to operate in a particular O-RU configuration. Instead, the single-entity O-RU 106 can be configured at run-time to use the desired O-RU configuration. Also, each such O-RU entity can be configured for use with one or more carriers in a given RF band.

FIG. 5 is a block diagram illustrating one exemplary embodiment of a multi-entity O-RU 106 that can be used in the O-RAN DAS 100 of FIG. 1.

The multi-entity O-RU 106 further comprises one or more programmable devices 402 and software, firmware, or configuration logic 404. In general, the one or more programmable devices 402 and software, firmware, or configuration logic 404 included in the multi-entity O-RU 106 are implemented as described above in connection with FIG. 4, except that the programmable devices 402 and software, firmware, or configuration logic 404 are scaled so as to be able implement multiple O-RU entities instead of only a single O-RU entity, as is the case with the single-entity O-RU of FIG. 4.

In this exemplary embodiment, the multi-entity O-RU 106 comprises multiple RF modules 406. In general, each RF module 406 is implemented as described above in connection with FIG. 5, except that each physical multi-entity O-RU 106 includes multiple RF modules 406 instead of a single RF module 406. In one implementation of the embodiment shown in FIG. 5, a different, single RF module 406 is used for each O-RU entity that is implemented using that physical multi-entity O-RU 106. Also, in this exemplary embodiment, for each antenna 116, the antenna circuit 408 is configured to combine (for example, using one or more band combiners) the amplified analog RF signals output by the downlink signal paths associated with that antenna 116 of the various RF modules 406 and to output the resulting combined signal to that antenna 116. Likewise, in this exemplary embodiment, for each antenna 116, the antenna circuit 408 is configured to split (for example, using one or more band splitters) the uplink analog RF signals received from that antenna 116 in order to supply, to each of the uplink signal paths associated with that antenna 116 of each RF modules 406, a respective uplink analog RF signals for that signal path.

The multi-entity O-RU 106 further comprises at least one network interface 410 that is configured to communicatively couple the multi-entity O-RU 106 to the switched Ethernet 112 and, ultimately, the DAS CAN 102.

The multi-entity O-RU 106 is configured to implement multiple O-RU entities, where each such O-RU entity appears to the associated O-DU 104 (and the DAS CAN 102) as a separate logical O-RU entity. Each O-RU entity is implemented using one or more RF modules 406 and the programmable devices 402. In one implementation, each multi-entity O-RU 106 is configured so that the processing and hardware resources provided by the O-RU 106 can be used to implement different O-RU entities (and be used with different O-DUs 104 or other base station entities) in a flexible manner. In such an implementation, a single physical multi-entity O-RU 106 can be used with multiple O-DUs 104 (or other base station entities) to serve multiple cells using multiple logical O-RU entities, where the processing and hardware resources used for the multiple O-RUs entities need not be configured and used in the same way. Also, each such O-RU entity may be used with a different O-DU 104 (or other base station entity) and may be used with a different simulcast group. In one implementation, the multi-entity O-RU 106 is not “hardwired” to operate in certain O-RU configurations. Instead, the multi-entity O-RU 106 can be configured at run-time to use the desired O-RU configurations. Also, each such O-RU entity can be configured for use with one or more carriers in a given RF band.

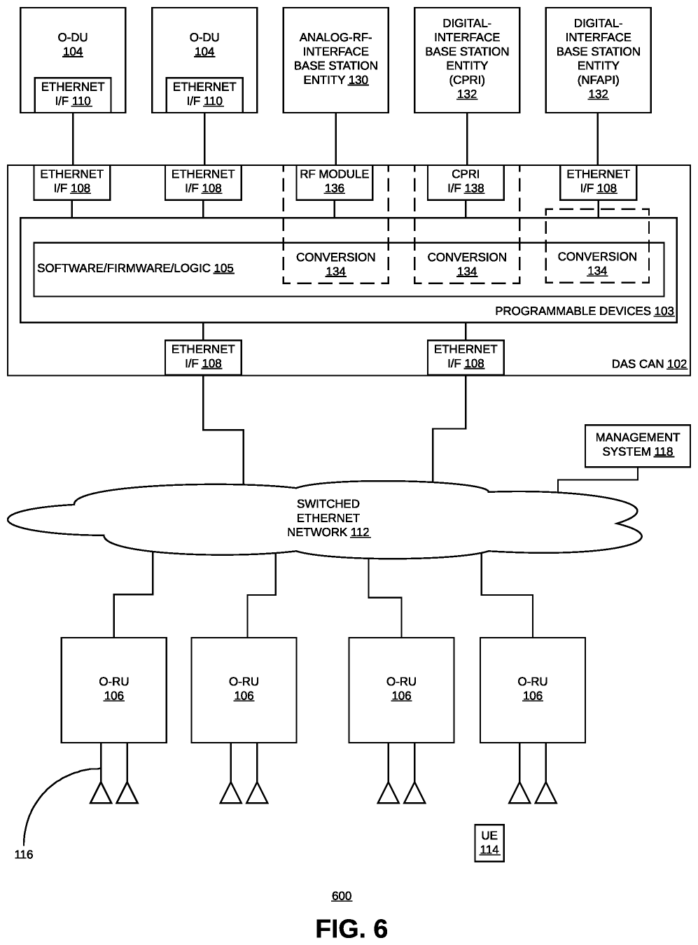

The exemplary embodiment of the O-RAN DAS 100 shown in FIG. 1 is described as being used only with O-DUs 104 that natively support the fronthaul interface (and associated functional split) used for transporting fronthaul data within the O-RAN DAS 100. In other embodiments, the O-RAN DAS 100 is configured to be used with other types of base station entities that do not natively support the fronthaul interface (and associated functional split) used for transporting fronthaul data within the O-RAN DAS 100. In such embodiments, the DAS CAN 102 of the O-RAN DAS 100 includes one or more conversion modules that convert between the fronthaul interface natively supported by such a base station entity and the fronthaul interface natively used in the O-RAN DAS 100. One example of such an embodiment is shown in FIG. 6.

FIG. 6 illustrates one exemplary embodiment of an O-RAN DAS 600 that supports base station entities that do not natively support the fronthaul interface used in the O-RAN DAS 600. In general, the O-RAN DAS 600 is the same as the O-RAN DAS 100 described above in connection with FIG. 1 and, except as set forth below in connection with FIG. 6, the description set forth above in connection with FIG. 1 applies to the embodiment shown in FIG. 6 and is not repeated below for the sake of brevity. The O-RAN DAS 600 can be implemented using one or more DAS CANs 102, where each DAS CAN 102 can be communicatively coupled to one or more O-DUs 104 and/or other base station entities. In the embodiment shown in FIG. 6, only one DAS CAN 102 is shown; however, it is to be understood that the O-RAN DAS 600 can include multiple DAS CANs 102, and each of the DAS CANs 102 need not be configured in the same way or for use with the same type or number of O-DUs 104 or other base station entities as the other DAS CANs 102 (if any) used in the O-RAN DAS 600.

In the embodiment shown in FIG. 6, at least one base station entity 130 is configured to interface with the O-RAN DAS 600 using an analog RF interface. This type of base station entity 130 is also referred to here as an “analog-RF-interface base station entity” 130. Such an analog-RF-interface base station entity 130 can be implemented, for example, using a remote radio head (RRH) that is deployed at the same site as the DAS CAN 102, where the associated baseband unit (BBU) can be co-located with the RRH at that site or can be deployed remotely from that site. Such an analog-RF-interface base station entity 130 can be implemented in other ways (for example, using a single-node small cell base station (such as a femtocell) deployed at the same site as the DAS CAN 102). Such an analog-RF-interface base station entity 130 can be implemented using legacy base station equipment that supports older wireless interface protocols (for example, older commercial cellular wireless interface protocols such as a Second Generation (2G), Third Generation (3G), or Fourth Generation (4G) wireless interface protocol and older trunked radio or other public safety wireless interface protocols such a Terrestrial Trunked Radio (TETRA) wireless interface protocol). Such an analog-RF-interface base station entity 130 can be implemented using new base station equipment that supports newer wireless interface protocols (such as a 5G wireless interface protocol). Examples of such new base station equipment include distributed base station equipment that uses proprietary fronthaul interfaces between the BBU and RRH functions or single-node base stations or access points that only have an external backhaul interface and external analog RF antenna interface. Analog-RF-interface base station entities 130 can be implemented in other ways.

In the embodiment shown in FIG. 6, at least one base station entity 132 is configured to interface with the O-RAN DAS 600 using a digital fronthaul interface that differs from the digital fronthaul interface natively used in the O-RAN DAS 600. This type of base station entity 132 is also referred to here as an “digital-interface base station entity” 132.

The digital-interface base station node 132 can be implemented using base station equipment typically used to provide 4G service. For example, the digital-interface base station entity 132 can be implemented as or using a 4G BBU that natively supports a fronthaul interface that uses an Option 8 functional split such as a CPRI interface, an Open Radio Equipment Interface (ORI) interface, or an Open Base Station Standard Initiative (“OBSAI”) interface. The BBU can be deployed without a corresponding RRH at the same site as the DAS CAN 102.

The digital-interface base station entity 132 can also be implemented using base station equipment typically used to provide 5G service. In one 5G example, the digital-interface base station entity 132 includes an O-RAN DU that is configured to natively use an O-RAN fronthaul interface that differs from the fronthaul interface natively used in the O-RAN DAS 600. In another 5G example, the digital-interface base station entity 132 includes a non-O-RAN 5G BBU that is configured to natively use a digital fronthaul interface (for example, an evolved Common Public Radio Interface (eCPRI) interface, an IEEE 1914.3 Radio-over-Ethernet (ROE) interface, or a functional application programming interface (FAPI) or network FAPI (nFAPI) interface) that differs from the digital fronthaul interface natively used in the O-RAN DAS 600. Although some examples of digital-interface base station entities 132 are described here as a “4G example” or a “5G example,” it is to be understood that such digital-interface base station entities 132 can be used to provide service using other wireless interface protocols in addition to or instead of 4G service or 5G service, respectively.

For any base station entity 130 or 132 that does not natively support the fronthaul interface natively used in the O-RAN DAS 600, the DAS CAN 102 includes a conversion module 134 that is configured to between the fronthaul interface natively supported by the base station entity 130 or 132 and the fronthaul interface natively used in the O-RAN DAS 600.

Each conversion module 134 that is used with an analog-RF-interface base station entity 130 includes an RF module 136 to receive and transmit downlink and uplink analog RF signals with that base station entity 130.

Also, for a digital-interface base station entity 132 that does not communicate with the DAS CAN 102 using an Ethernet interface 108, the corresponding conversion module 134 includes an appropriate digital interface 138 to communicate with that base station entity 132. For example, where the digital-interface base station entity 132 communicates with the DAS CAN 102 using synchronous CPRI frames, the corresponding conversion module 134 includes an CPRI interface to receive and transmit downlink and uplink CPRI frames with that base station entity 132.

In the embodiment shown in FIG. 6, at least some of the processing implemented by each conversion module 134 is implemented using the one or more programmable devices 103 and the associated software, firmware, or configuration logic 105.

In the embodiment described here in connection with FIG. 6, the O-RAN DAS 600 natively uses an O-RAN fronthaul interface based on the Option 7.2 functional split.

For each analog-RF-interface base station entity 130, a respective conversion module 134 can be configured to receive each downlink analog RF signal (including the various physical channels and associated sub carriers) output by the base station entity 130 via the respective RF module 136, generate corresponding time-domain baseband IQ data (for example, by performing an analog-to-digital (ADC) process using the RF module 136, outputting the digital data to the one or more programmable devices 103 (and the associate software, firmware, or configuration logic 105) used to implement that conversion module 134), and digitally downconverting and filtering the resulting digital data), and perform cyclic prefix (CP) removal and fast Fourier transform (FFT) processing in order to produce frequency-domain baseband IQ data in a form suitable for use with the O-RAN fronthaul interface. The conversion module 134 is configured to format the resulting frequency-domain baseband IQ data in accordance with the fronthaul interface natively used in the O-RAN DAS 600 (for example, by compressing frequency-domain baseband IQ data if needed and formatting the data in O-RAN user-plane messages). The conversion module 134 is also configured to generate corresponding O-RAN control-plane messages that will enable each O-RU 106 that receives the associated O-RAN user-plane messages to reconstruct a version of each original downlink analog RF signal using the O-RAN user-plane messages. The resulting formatted user-plane and control-plane data is then encapsulated in Ethernet frames and IP packets, where the destination address of the IP packets is the multicast address assigned to the associated simulcast group. The resulting IP packets are then transmitted by the DAS CAN 102 to that multicast address and, as a result, to the O-RUs 106 in the associated simulcast group. The O-RUs 106 use the IP packets to reconstruct a version of each original downlink analog RF signal and radiate it from respective antennas 116 associated with the O-RUs 106.

In the uplink direction, the conversion module 134 receives the summed uplink packets produced for the cell served by the associated analog-RF-interface base station entity 130, extracts the summed uplink baseband IQ data, and uses the extracted summed uplink baseband IQ data to generate each uplink analog RF signal to be output to that base station entity 130. In this example where the O-RAN DAS 600 natively uses an O-RAN fronthaul interface based on the Option 7.2 functional split, for each uplink analog RF signal output to the base station entity 130, the conversion module 134 performs any decompression processing that is required, performs inverse FFT (IFFT) processing and CP insertion in order to produce time-domain baseband IQ data for any channels requiring such processing, combines the time-domain baseband IQ data for the various channels, and generates the uplink analog RF signal from the time-domain baseband IQ data for all channels (for example, by digitally up-converting the time-domain baseband IQ data and then performing a digital-to-analog (DAC) process using the respective RF module 136). Each generated uplink analog RF signal is output to the base station entity 130 via the respective RF module 136.

For each digital-interface base station entity 132 that natively supports a fronthaul interface based on an Option 8 functional split (a CPRI interface in this example), a respective conversion module 134 can be configured to receive the downstream CPRI frames output by the base station entity 132 using the associated CPRI interface 138, output the downlink CPRI frames to the one or more programmable devices 103 (and the associated software, firmware, or configuration logic 105) used to implement that conversion module 134, and extract the time-domain baseband IQ data for each antenna carrier as well as the synchronization and control data. For each downlink antenna carrier, the conversion module 134 is configured to perform CP removal and FFT processing in order to produce frequency-domain baseband IQ data in a form suitable for use with the O-RAN fronthaul interface. The conversion module 134 is configured to format the resulting frequency-domain baseband IQ data in accordance with the fronthaul interface natively used in the O-RAN DAS 600 (for example, by compressing frequency-domain baseband IQ data if needed and formatting the data in O-RAN user-plane messages). The conversion module 134 is also configured to generate corresponding O-RAN control-plane messages that will enable each O-RU 106 that receives the associated O-RAN user-plane messages to generate an appropriate downlink analog RF signal for each antenna carrier using the O-RAN user-plane messages. The resulting formatted user-plane and control-plane data is then encapsulated in Ethernet frames and IP packets and transmitted to the multicast address assigned to the associated simulcast group as described above so that the O-RUs 106 in the simulcast group can use the IP packets to generate an appropriate downlink analog RF signal for each antenna carrier and radiate it from respective antennas 116 associated with the O-RUs 106.

In the uplink direction, the conversion module 134 receives the summed uplink packets produced for the cell served by the associated digital-interface base station entity 132, extracts the summed uplink baseband IQ data, and uses the extracted summed uplink frequency-domain baseband IQ data to generate CPRI frames including the various uplink antenna carriers. In this example where the O-RAN DAS 600 natively uses an O-RAN fronthaul interface based on the Option 7.2 functional split, for each uplink antenna carrier output to the base station entity 132, the conversion module 134 performs any decompression processing that is required, performs IFFT processing and CP insertion in order to produce time-domain baseband IQ data for any channels requiring such processing, and combines the time-domain baseband IQ data for the various channels for that uplink antenna carrier.

For each digital-interface base station entity 132 that natively supports a nFAPI fronthaul interface, a respective conversion module 134 can be configured to receive the downstream IP packets output by the base station entity 132 using one or more of the Ethernet interfaces 108 and output the received downlink packets to the one or more programmable devices 103 (and the associated software, firmware, or configuration logic 105) used to implement that conversion module 134. The conversion module 134 performs the high PHY processing for the received downlink packets in order to produce downlink IP user-plane and control-plane packets in accordance with the O-RAN fronthaul interface natively used in the O-RAN DAS 600 (which in this example is an O-RAN fronthaul interface based on the Option 7.2 functional split). The resulting IP packets are transmitted to the multicast address assigned to the associated simulcast group as described above so that the O-RUs 106 in the simulcast group can use the IP packets to generate an appropriate downlink analog RF signal for each antenna carrier and radiate it from respective antennas 116 associated with the O-RUs 106. In the uplink direction, the conversion module 134 receives the summed uplink packets produced for the cell served by the associated digital-interface base station entity 132, performs the high PHY processing for the received uplink packets in order to produce uplink IP user-plane and control-plane packets that are communicated to the associated digital-interface base station entity 132 via one or more of the Ethernet interfaces 108.

The conversion modules 134 can be configured to be used with other types of base station entities that support other interfaces.

By using conversion modules 134, base station entities that do not natively support the fronthaul interface used in the O-RAN DAS 600 can nevertheless be used with the O-RAN DAS 600.

### EXAMPLE EMBODIMENTS

Example 1 includes an open radio access network (O-RAN) distributed antenna system (DAS) comprising: a central access node (CAN) configured to communicatively couple at least one O-RAN distributed unit (O-DU) to the O-RAN DAS, wherein the O-DU is configured to communicate with a single O-RAN remote unit (O-RU) entity; and a plurality of O-RAN remote units (O-RUs) communicatively coupled to the CAN over a fronthaul network, wherein the O-DU, CAN, and O-RUs are configured to natively use an O-RAN fronthaul interface to communicate fronthaul data over the fronthaul network; wherein the CAN is configured to appear to the O-DU as the single O-RU entity for a cell served by the O-DU even though the CAN is configured to serve the cell using multiple O-RUs that form a simulcast group for that cell; wherein the CAN is configured to: receive, at the CAN, each downlink packet for downlink O-RAN control-plane and user-plane communications transmitted from each O-DU using a unicast destination address; change the destination unicast address of each received downlink control-plane and user-plane packet to a multicast address associated with the simulcast group used for the cell; transmit each updated downlink control-plane and user-plane packet to the multiple O-RUs in the simulcast group using the multicast address; receive, at the CAN, each uplink packet for uplink O-RAN user-plane communications transmitted from the multiple O-RUs in the simulcast group for the cell; perform a digital summation process for corresponding uplink baseband IQ samples in corresponding uplink user-plane packets received from the multiple O-RUs in the simulcast group for the cell in order to produce respective summed uplink packets including the summed uplink based IQ samples; and transmit the summed uplink packets to the O-DU.

Example 2 includes the O-RAN DAS of Example 1, wherein at least some of the O-RUs are remotely located from the CAN and from at least one other O-RU.

Example 3 includes the O-RAN DAS of any of Examples 1-2, wherein the CAN is configured to communicatively couple multiple O-DUs to the O-RAN DAS, wherein the CAN is configured to appear to the each of the multiple O-DU as a respective single O-RU entity for a respective cell served by each O-DU even though the CAN is configured to serve the respective cell using a respective group of multiple O-RUs that form a respective simulcast group for that cell.

Example 4 includes the O-RAN DAS of any of Examples 1-3, wherein the CAN is further configured to perform at least some processing for the cell that the O-DU expects to be performed in an O-RU entity for at least some of the received downlink control-plane and user-plane packets, wherein processed downlink data resulting from the at least some processing is included in the corresponding updated downlink packets transmitted to the multiple O-RUs in the simulcast group for the cell using the multicast address.

Example 5 includes the O-RAN DAS of Example 4, wherein the at least some processing for the cell that the O-DU expects to be performed in an O-RU entity for at least some of the received downlink control-plane and user-plane packets comprises at least one of precoding, digital beamforming, decompression, and compression.

Example 6 includes the O-RAN DAS of any of Examples 1-5, wherein the CAN is further configured to perform at least some processing for the cell that the O-DU expects to be performed in an O-RU entity for at least some of the received uplink user-plane packets or for at least some of the summed user-plane packets, wherein processed uplink data resulting from the at least some processing is included in the corresponding summed uplink packets transmitted to the O-DU.

Example 7 includes the O-RAN DAS of Example 6, wherein the at least some processing for the cell that the O-DU expects to be performed in an O-RU entity for at least some of the received uplink user-plane packets or for at least some of the summed user-plane packets comprises at least one of digital beamforming, decompression, and compression.

Example 8 includes the O-RAN DAS of any of Examples 1-7, wherein the CAN, the O-DU, and the O-RUs are configured to use a time synchronization protocol supported by O-RAN to synchronize to a timing master entity established for the O-RAN DAS.

Example 9 includes the O-RAN DAS of Example 8, wherein time synchronization protocol supported by O-RAN comprises at least one of the Institute of Electrical and Electronics Engineers (IEEE) 1588 Precision Time Protocol (PTP) and Synchronous Ethernet (SyncE) protocol.

Example 10 includes the O-RAN DAS of any of Examples 1-9, wherein each O-RU comprises one of: a single-entity O-RU comprising a single physical O-RU configured to implement a single O-RU entity; and a multi-entity O-RU comprising a single physical O-RU configured to implement multiple O-RU entities.

Example 11 includes the O-RAN DAS of any of Examples 1-10, wherein the CAN is configured to be used with at least one base station entity that does not natively support the O-RAN fronthaul interface that the O-DU, CAN, and O-RUs are configured to natively use to communicate fronthaul data over the fronthaul network, wherein the CAN comprises at least one conversion module configured to convert between a fronthaul interface natively supported by the base station entity and the O-RAN fronthaul interface that the O-DU, CAN, and O-RUs are configured to natively use to communicate fronthaul data over the fronthaul network.

Example 12 includes the O-RAN DAS of Example 11, wherein the base station entity is configured to interface with the O-RAN DAS using an analog RF interface, wherein the CAN is configured to serve a second cell using the base station entity and second group of multiple O-RUs that form a second simulcast group for the second cell; wherein the O-RAN fronthaul interface that the O-DU, CAN, and O-RUs are configured to natively use to communicate fronthaul data over the fronthaul network comprises an O-RAN fronthaul interface based on an Option Example 7.2 functional split; wherein the conversion module is configured to receive each downlink analog RF signal output by the base station entity, generate O-RAN downlink control-plane and user-plane packets, and transmit the generated O-RAN downlink control-plane and user-plane packets to multiple O-RUs in a simulcast group using the multicast address; wherein the CAN is configured to: receive, at the CAN, each uplink packet for uplink O-RAN user-plane communications transmitted from the second group of multiple O-RUs in the second simulcast group for the second cell; and perform the digital summation process for corresponding uplink baseband IQ samples in corresponding uplink user-plane packets received from the second group of multiple O-RUs in the second simulcast group for the second cell in order to produce respective summed uplink packets including the summed uplink based IQ samples; and wherein the conversion module is configured to receive the summed uplink packets produced for the second cell and generate one or more uplink analog RF signals that are output to the base station entity.

Example 13 includes the O-RAN DAS of any of Examples 11-12, wherein the base station entity is configured to interface with the O-RAN DAS using an Option 8 functional split, wherein the CAN is configured to serve a second cell using the base station entity and second group of multiple O-RUs that form a second simulcast group for the second cell; wherein the O-RAN fronthaul interface that the O-DU, CAN, and O-RUs are configured to natively use to communicate fronthaul data over the fronthaul network comprises an O-RAN fronthaul interface based on an Option Example 7.2 functional split; wherein the conversion module is configured to receive downlink control-plane and user-plane data outputted by the base station entity using the fronthaul interface natively supported by the base station entity, generate O-RAN downlink control-plane and user-plane packets, and transmit the generated O-RAN downlink control-plane and user-plane packets to multiple O-RUs in a simulcast group using the multicast address; wherein the CAN is configured to: receive, at the CAN, each uplink packet for uplink O-RAN user-plane communications transmitted from the second group of multiple O-RUs in the second simulcast group for the second cell; and perform the digital summation process for corresponding uplink baseband IQ samples in corresponding uplink user-plane packets received from the second group of multiple O-RUs in the second simulcast group for the second cell in order to produce respective summed uplink packets including the summed uplink based IQ samples; and wherein the conversion module is configured to receive the summed uplink packets produced for the second cell and generate, and output to the base station entity, uplink control-plane and user-plane data formatted according to the fronthaul interface natively supported by the base station entity.

Example 14 includes the O-RAN DAS of any of Examples 11-13, wherein the base station entity is configured to natively support a functional application programming interface (FAPI) or a network FAPI (nFAPI) interface, wherein the CAN is configured to serve a second cell using the base station entity and second group of multiple O-RUs that form a second simulcast group for the second cell; wherein the O-RAN fronthaul interface that the O-DU, CAN, and O-RUs are configured to natively use to communicate fronthaul data over the fronthaul network comprises an O-RAN fronthaul interface based on an Option Example 7.2 functional split; wherein the conversion module is configured to receive downlink control-plane and user-plane data outputted by the base station entity using the FAPI or nFAPI interface natively supported by the base station entity, generate O-RAN downlink control-plane and user-plane packets, and transmit the generated O-RAN downlink control-plane and user-plane packets to multiple O-RUs in a simulcast group using the multicast address; wherein the CAN is configured to: receive, at the CAN, each uplink packet for uplink O-RAN user-plane communications transmitted from the second group of multiple O-RUs in the second simulcast group for the second cell; and perform the digital summation process for corresponding uplink baseband IQ samples in corresponding uplink user-plane packets received from the second group of multiple O-RUs in the second simulcast group for the second cell in order to produce respective summed uplink packets including the summed uplink based IQ samples; and wherein the conversion module is configured to receive the summed uplink packets produced for the second cell and generate, and output to the base station entity, uplink FAPI or nFAPI control-plane and user-plane data.

Example 15 includes the O-RAN DAS of any of Examples 1-14, wherein the O-RAN DAS comprises a plurality of CANs.

Example 16 includes a method for use with an open radio access network (O-RAN) distributed antenna system (DAS), the O-RAN DAS comprises a central access node (CAN) configured to communicatively couple at least one O-RAN distributed unit (O-DU) to the O-RAN DAS, wherein the O-DU is configured to communicate with a single O-RAN remote unit (O-RU) entity, wherein the O-RAN DAS further comprises a plurality of O-RAN remote units (O-RUs) communicatively coupled to the CAN over a fronthaul network, wherein the O-DU, CAN, and O-RUs are configured to natively use an O-RAN fronthaul interface to communicate fronthaul data over the fronthaul network, wherein the CAN is configured to appear to the O-DU as the single O-RU entity for a cell served by the O-DU even though the CAN is configured to serve the cell using multiple O-RUs that form a simulcast group for that cell, wherein the method comprises: receiving, at the CAN, each downlink packet for downlink O-RAN control-plane and user-plane communications transmitted from each O-DU using a unicast destination address; changing the destination unicast address of each received downlink control-plane and user-plane packet to a multicast address associated with the simulcast group used for the cell; transmitting each updated downlink control-plane and user-plane packet to the multiple O-RUs in the simulcast group using the multicast address; receiving, at the CAN, each uplink packet for uplink O-RAN user-plane communications transmitted from the multiple O-RUs in the simulcast group for the cell; performing a digital summation process for corresponding uplink baseband IQ samples in corresponding uplink user-plane packets received from the multiple O-RUs in the simulcast group for the cell in order to produce respective summed uplink packets including the summed uplink based IQ samples; and transmitting the summed uplink packets to the O-DU.

Example 17 includes the method of Example 16, further comprising performing, by the CAN, at least some processing for the cell that the O-DU expects to be performed in an O-RU entity for at least some of the received downlink control-plane and user-plane packets, wherein processed downlink data resulting from the at least some processing is included in the corresponding updated downlink packets transmitted to the multiple O-RUs in the simulcast group for the cell using the multicast address.

Example 18 includes the method of Example 17, wherein the at least some processing for the cell that the O-DU expects to be performed in an O-RU entity for at least some of the received downlink control-plane and user-plane packets comprises at least one of precoding, digital beamforming, decompression, and compression.

Example 19 includes the method of any of Examples 16-18, further comprising performing, by the CAN, at least some processing for the cell that the O-DU expects to be performed in an O-RU entity for at least some of the received uplink user-plane packets or for at least some of the summed user-plane packets, wherein processed uplink data resulting from the at least some processing is included in the corresponding summed uplink packets transmitted to the O-DU.

Example 20 includes the method of Example 19, wherein the at least some processing for the cell that the O-DU expects to be performed in an O-RU entity for at least some of the received uplink user-plane packets or for at least some of the summed user-plane packets comprises at least one of digital beamforming, decompression, and compression.

Example 21 includes the method of any of Examples 16-20, wherein the CAN is configured to be used with at least one base station entity that does not natively support the O-RAN fronthaul interface that the O-DU, CAN, and O-RUs are configured to natively use to communicate fronthaul data over the fronthaul network, wherein the method further comprises converting between a fronthaul interface natively supported by the base station entity and the O-RAN fronthaul interface that the O-DU, CAN, and O-RUs are configured to natively use to communicate fronthaul data over the fronthaul network.

Example 22 includes the method of any of Examples 16-21, wherein the O-RAN DAS comprises a plurality of CANs.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. An open radio access network (O-RAN) distributed antenna system (DAS) comprising:
a central access node (CAN) configured to communicatively couple at least one O-RAN distributed unit (O-DU) to the O-RAN DAS, wherein the O-DU is configured to communicate with a single O-RAN remote unit (O-RU) entity; and
a plurality of O-RAN remote units (O-RUs) communicatively coupled to the CAN over a fronthaul network, wherein the O-DU, CAN, and O-RUs are configured to natively use an O-RAN fronthaul interface to communicate fronthaul data over the fronthaul network;
wherein the CAN is configured to appear to the O-DU as the single O-RU entity for a cell served by the O-DU even though the CAN is configured to serve the cell using multiple O-RUs that form a simulcast group for that cell;
wherein the CAN is configured to:
receive, at the CAN, each downlink packet for downlink O-RAN control-plane and user-plane communications transmitted from each O-DU using a unicast destination address;
change the destination unicast address of each received downlink control-plane and user-plane packet to a multicast address associated with the simulcast group used for the cell;
transmit each updated downlink control-plane and user-plane packet to the multiple O-RUs in the simulcast group using the multicast address;
receive, at the CAN, each uplink packet for uplink O-RAN user-plane communications transmitted from the multiple O-RUs in the simulcast group for the cell;
perform a digital summation process for corresponding uplink baseband IQ samples in corresponding uplink user-plane packets received from the multiple O-RUs in the simulcast group for the cell in order to produce respective summed uplink packets including the summed uplink based IQ samples; and
transmit the summed uplink packets to the O-DU.

2. The O-RAN DAS of claim 1, wherein at least some of the O-RUs are remotely located from the CAN and from at least one other O-RU.

3. The O-RAN DAS of claim 1, wherein the CAN is configured to communicatively couple multiple O-DUs to the O-RAN DAS, wherein the CAN is configured to appear to the each of the multiple O-DU as a respective single O-RU entity for a respective cell served by each O-DU even though the CAN is configured to serve the respective cell using a respective group of multiple O-RUs that form a respective simulcast group for that cell.

4. The O-RAN DAS of claim 1, wherein the CAN is further configured to perform at least some processing for the cell that the O-DU expects to be performed in an O-RU entity for at least some of the received downlink control-plane and user-plane packets, wherein processed downlink data resulting from the at least some processing is included in the corresponding updated downlink packets transmitted to the multiple O-RUs in the simulcast group for the cell using the multicast address.

5. The O-RAN DAS of claim 4, wherein the at least some processing for the cell that the O-DU expects to be performed in an O-RU entity for at least some of the received downlink control-plane and user-plane packets comprises at least one of precoding, digital beamforming, decompression, and compression.

6. The O-RAN DAS of claim 1, wherein the CAN is further configured to perform at least some processing for the cell that the O-DU expects to be performed in an O-RU entity for at least some of the received uplink user-plane packets or for at least some of the summed user-plane packets, wherein processed uplink data resulting from the at least some processing is included in the corresponding summed uplink packets transmitted to the O-DU.

7. The O-RAN DAS of claim 6, wherein the at least some processing for the cell that the O-DU expects to be performed in an O-RU entity for at least some of the received uplink user-plane packets or for at least some of the summed user-plane packets comprises at least one of digital beamforming, decompression, and compression.

8. The O-RAN DAS of claim 1, wherein the CAN, the O-DU, and the O-RUs are configured to use a time synchronization protocol supported by O-RAN to synchronize to a timing master entity established for the O-RAN DAS.

9. The O-RAN DAS of claim 8, wherein time synchronization protocol supported by O-RAN comprises at least one of the Institute of Electrical and Electronics Engineers (IEEE) 1588 Precision Time Protocol (PTP) and Synchronous Ethernet (SyncE) protocol.

10. The O-RAN DAS of claim 1, wherein each O-RU comprises one of:
a single-entity O-RU comprising a single physical O-RU configured to implement a single O-RU entity; and
a multi-entity O-RU comprising a single physical O-RU configured to implement multiple O-RU entities.

11. The O-RAN DAS of claim 1, wherein the CAN is configured to be used with at least one base station entity that does not natively support the O-RAN fronthaul interface that the O-DU, CAN, and O-RUs are configured to natively use to communicate fronthaul data over the fronthaul network, wherein the CAN comprises at least one conversion module configured to convert between a fronthaul interface natively supported by the base station entity and the O-RAN fronthaul interface that the O-DU, CAN, and O-RUs are configured to natively use to communicate fronthaul data over the fronthaul network.

12. The O-RAN DAS of claim 11, wherein the base station entity is configured to interface with the O-RAN DAS using an analog RF interface, wherein the CAN is configured to serve a second cell using the base station entity and second group of multiple O-RUs that form a second simulcast group for the second cell;
wherein the O-RAN fronthaul interface that the O-DU, CAN, and O-RUs are configured to natively use to communicate fronthaul data over the fronthaul network comprises an O-RAN fronthaul interface based on an Option 7.2 functional split;
wherein the conversion module is configured to receive each downlink analog RF signal output by the base station entity, generate O-RAN downlink control-plane and user-plane packets, and transmit the generated O-RAN downlink control-plane and user-plane packets to multiple O-RUs in a simulcast group using the multicast address;
wherein the CAN is configured to:
receive, at the CAN, each uplink packet for uplink O-RAN user-plane communications transmitted from the second group of multiple O-RUs in the second simulcast group for the second cell; and
perform the digital summation process for corresponding uplink baseband IQ samples in corresponding uplink user-plane packets received from the second group of multiple O-RUs in the second simulcast group for the second cell in order to produce respective summed uplink packets including the summed uplink based IQ samples; and
wherein the conversion module is configured to receive the summed uplink packets produced for the second cell and generate one or more uplink analog RF signals that are output to the base station entity.

13. The O-RAN DAS of claim 11, wherein the base station entity is configured to interface with the O-RAN DAS using an Option 8 functional split, wherein the CAN is configured to serve a second cell using the base station entity and second group of multiple O-RUs that form a second simulcast group for the second cell;
wherein the O-RAN fronthaul interface that the O-DU, CAN, and O-RUs are configured to natively use to communicate fronthaul data over the fronthaul network comprises an O-RAN fronthaul interface based on an Option 7.2 functional split;
wherein the conversion module is configured to receive downlink control-plane and user-plane data outputted by the base station entity using the fronthaul interface natively supported by the base station entity, generate O-RAN downlink control-plane and user-plane packets, and transmit the generated O-RAN downlink control-plane and user-plane packets to multiple O-RUs in a simulcast group using the multicast address;
wherein the CAN is configured to:
receive, at the CAN, each uplink packet for uplink O-RAN user-plane communications transmitted from the second group of multiple O-RUs in the second simulcast group for the second cell; and
perform the digital summation process for corresponding uplink baseband IQ samples in corresponding uplink user-plane packets received from the second group of multiple O-RUs in the second simulcast group for the second cell in order to produce respective summed uplink packets including the summed uplink based IQ samples; and
wherein the conversion module is configured to receive the summed uplink packets produced for the second cell and generate, and output to the base station entity, uplink control-plane and user-plane data formatted according to the fronthaul interface natively supported by the base station entity.

14. The O-RAN DAS of claim 11, wherein the base station entity is configured to natively support a functional application programming interface (FAPI) or a network FAPI (nFAPI) interface, wherein the CAN is configured to serve a second cell using the base station entity and second group of multiple O-RUs that form a second simulcast group for the second cell;
wherein the O-RAN fronthaul interface that the O-DU, CAN, and O-RUs are configured to natively use to communicate fronthaul data over the fronthaul network comprises an O-RAN fronthaul interface based on an Option 7.2 functional split;
wherein the conversion module is configured to receive downlink control-plane and user-plane data outputted by the base station entity using the FAPI or nFAPI interface natively supported by the base station entity, generate O-RAN downlink control-plane and user-plane packets, and transmit the generated O-RAN downlink control-plane and user-plane packets to multiple O-RUs in a simulcast group using the multicast address;
wherein the CAN is configured to:
receive, at the CAN, each uplink packet for uplink O-RAN user-plane communications transmitted from the second group of multiple O-RUs in the second simulcast group for the second cell; and
perform the digital summation process for corresponding uplink baseband IQ samples in corresponding uplink user-plane packets received from the second group of multiple O-RUs in the second simulcast group for the second cell in order to produce respective summed uplink packets including the summed uplink based IQ samples; and
wherein the conversion module is configured to receive the summed uplink packets produced for the second cell and generate, and output to the base station entity, uplink FAPI or nFAPI control-plane and user-plane data.

15. The O-RAN DAS of claim 1, wherein the O-RAN DAS comprises a plurality of CANs.

16. A method for use with an open radio access network (O-RAN) distributed antenna system (DAS), the O-RAN DAS comprises a central access node (CAN) configured to communicatively couple at least one O-RAN distributed unit (O-DU) to the O-RAN DAS, wherein the O-DU is configured to communicate with a single O-RAN remote unit (O-RU) entity, wherein the O-RAN DAS further comprises a plurality of O-RAN remote units (O-RUs) communicatively coupled to the CAN over a fronthaul network, wherein the O-DU, CAN, and O-RUs are configured to natively use an O-RAN fronthaul interface to communicate fronthaul data over the fronthaul network, wherein the CAN is configured to appear to the O-DU as the single O-RU entity for a cell served by the O-DU even though the CAN is configured to serve the cell using multiple O-RUs that form a simulcast group for that cell, wherein the method comprises:
receiving, at the CAN, each downlink packet for downlink O-RAN control-plane and user-plane communications transmitted from each O-DU using a unicast destination address;
changing the destination unicast address of each received downlink control-plane and user-plane packet to a multicast address associated with the simulcast group used for the cell;
transmitting each updated downlink control-plane and user-plane packet to the multiple O-RUs in the simulcast group using the multicast address;
receiving, at the CAN, each uplink packet for uplink O-RAN user-plane communications transmitted from the multiple O-RUs in the simulcast group for the cell;
performing a digital summation process for corresponding uplink baseband IQ samples in corresponding uplink user-plane packets received from the multiple O-RUs in the simulcast group for the cell in order to produce respective summed uplink packets including the summed uplink based IQ samples; and
transmitting the summed uplink packets to the O-DU.

17. The method of claim 16, further comprising performing, by the CAN, at least some processing for the cell that the O-DU expects to be performed in an O-RU entity for at least some of the received downlink control-plane and user-plane packets, wherein processed downlink data resulting from the at least some processing is included in the corresponding updated downlink packets transmitted to the multiple O-RUs in the simulcast group for the cell using the multicast address.

18. The method of claim 17, wherein the at least some processing for the cell that the O-DU expects to be performed in an O-RU entity for at least some of the received downlink control-plane and user-plane packets comprises at least one of precoding, digital beamforming, decompression, and compression.

19. The method of claim 16, further comprising performing, by the CAN, at least some processing for the cell that the O-DU expects to be performed in an O-RU entity for at least some of the received uplink user-plane packets or for at least some of the summed user-plane plane packets, wherein processed uplink data resulting from the at least some processing is included in the corresponding summed uplink packets transmitted to the O-DU.

20. The method of claim 19, wherein the at least some processing for the cell that the O-DU expects to be performed in an O-RU entity for at least some of the received uplink user-plane packets or for at least some of the summed user-plane packets comprises at least one of digital beamforming, decompression, and compression.

21. The method of claim 16, wherein the CAN is configured to be used with at least one base station entity that does not natively support the O-RAN fronthaul interface that the O-DU, CAN, and O-RUs are configured to natively use to communicate fronthaul data over the fronthaul network, wherein the method further comprises converting between a fronthaul interface natively supported by the base station entity and the O-RAN fronthaul interface that the O-DU, CAN, and O-RUs are configured to natively use to communicate fronthaul data over the fronthaul network.

22. The method of claim 16, wherein the O-RAN DAS comprises a plurality of CANs.
